(19) United States
(12) Patent Application Publication
(10) Pub. No.: US 2008/0275889 A1
(43) Pub. Date: Nov. 6, 2008

(54) Method and system for assessing the staffing needs of an organization

(75) Inventors: Meng-Ling Hsiao, Niskayuna, NY (US); Sathish Nasana, Schenectady, NY (US); Bill Meeker, Glenville, NY (US); Brian Randolph Moore, Wilmington, NC (US); Mark Dubecky, Wilmington, NC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/799,160

(22) Filed: May 1, 2007

(51) Int. Cl. G06F 17/30

(52) U.S. Cl. 707/100

(57) ABSTRACT

A method and system for creating a functional depth chart of an organization is provided. The method and system may include comparing a selected function requirement of the organization with a selected employee, if an employee is present within the organization. The method and system may also illustrate the results on the aforementioned comparison in a functional depth chart. The method and system may also illustrate a plurality of functional depth charts. The method and system may also include a search function.

### BACKGROUND OF THE INVENTION

The present application relates generally to a method and system for evaluating human resource needs within an organization; and more particularly to a method and system for assessing the functional depth of an organization.

Leaders in modern business organizations have increasingly complex management roles covering the various facets of the organization. Leaders generally have different goals and objectives; however, most may need to ensure that the organization is staffed with a sufficient amount of employees having the skills to fulfill the organization functions.

Typically, organizations may have new or changing functions along with a changing workforce. As functions are added or changed, the employees must be capable of fulfilling those functions. Furthermore, leaders, particularly high-level leaders, have a difficult time in quickly and accurately determining whether the organization has adequate human resources to fulfill the functions. Moreover, leaders typically develop staffing plans based on a perceived need versus an assessed need, leading to an inaccurate staffing plan.

Leaders may behave reactively in determining whether the organization has employees of a particular skill set. Furthermore, after a significant organization change, such as a merger or a divesture, accurately assessing the resulting workforce may prove difficult.

Currently, tools may exist to assess the skill set of employees. These tools may generically determine the proficiency level of employees.

There are a few possible problems with the currently known tools. The tools do not provide an objective process for comparing the employee skill set with the requirements of a selected organization function. The tools do not allow for a leader to define or change a function. The tools do not provide a leader with a simple way to either change an employee skill set or add a new employee; for comparison with a specific organization function. The tools do not indicate if none of the employees in the organization can fulfill a specific function. The tools do not determine whether or not the organization is adequately staffed with employees capable of fulfilling a specific function requirement

For the foregoing reasons, there is a need for a method and system for assessing the functional depth within an organization. The method and system should determine the requirements of at least one function in the organization. The method and system should determine whether or not the organization has an employee available for fulfilling the specified function. The method and system should also determine the skill set, including the rating and category of each of the plurality of employees within the organization. The method and system should compare the requirements of the at least one function with the skill set of at least one employee. The method and system should also determine whether or not the organization has an employee available for fulfilling the specified function. The method and system should also determine whether or not the organization is adequately staffed with employees capable of fulfilling a specific function requirement.

### BRIEF DESCRIPTION OF THE INVENTION

In accordance with an embodiment of the present invention, a method of assessing the functional depth of an organization, the method comprising: receiving a function requirement; wherein the step of receiving the function requirement is from at least one of a function requirement library and a new function requirement; confirming the function requirement, wherein the step of confirming is conducted by at least one member of the organization; determining whether at least one employee record exists; and if the at least one employee record exists then: receiving at least one employee record; wherein the step of receiving the at least one employee record is from at least one of an employee record database and a new employee record; confirming the at least one employee record, wherein the step of confirming is conducted by at least one member of the organization; comparing the function requirement and the at least one employee record; providing a function dataset, wherein the function dataset comprises data from the step of comparing the function requirement and at least one employee record; and plotting a functional depth chart; wherein the step of plotting the functional depth chart comprises incorporating the function dataset and portraying how each record of the plurality of employee records matches the function requirement.

In accordance with an alternate embodiment of the present invention, a method of assessing the functional depth of an organization, the method comprising: receiving a function requirement; wherein the step of receiving the function requirement is from at least one of a function requirement library and a new function requirement; confirming the function requirement, wherein the step of confirming is conducted by at least one member of the organization; determining whether at least one employee record exists; and if the at least one employee record exists then receiving at least one employee record; wherein the step of receiving the at least one employee record is from at least one of an employee record database and a new employee record; confirming the at least one employee record, wherein the confirmation is conducted by at least one member of the organization; comparing the function requirement and the at least one employee record; providing a function dataset, wherein the function dataset comprises data from the step of comparing the function requirement and at least one employee record; and plotting a functional depth chart; wherein the step of plotting the functional depth chart comprises incorporating the function dataset and portraying how each record of the plurality of employee records matches the function requirement; plotting an organizational dashboard, wherein the step of plotting the organizational dashboard comprises: receiving a plurality of functional datasets; and portraying the functional depth of a plurality of function requirements; providing a functional search tool, wherein the functional search tool comprises: receiving a functional search criteria; wherein the functional search criteria comprises at least one of: an employee data; a function requirement; an employee category; an employee rating; and a keyword; and providing the results of the functional search criteria.

In accordance with another alternate embodiment of the present invention, a system to assess the functional depth of an organization, the system comprising: means for receiving a function requirement; wherein the function requirement is received from at least one of a function requirement library and a new function requirement; and means for confirming the function requirement, wherein the confirming is conducted by at least one member of the organization; means for determining whether at least one employee record exist; and if the at least one employee record exists then: means for receiving at least one employee record; wherein at least one employee record is received from at least one of an employee record database and a new employee record; and confirming the at least one employee record, wherein the confirmation is conducted by at least one member of the organization; means for comparing the function requirement and the at least one employee record; means for providing a function dataset, wherein the function dataset comprises data from the step of comparing the function requirement and at least one employee record; and means for plotting a functional depth chart; wherein the functional depth chart comprises the incorporation of the function dataset, and wherein functional depth chart portrays how each record of the plurality of employee records matches the function requirement.

### BRIEF DESCRIPTION OF THE DRAWING

FIG. 1 is a flowchart illustrating an example of a method of creating a functional depth chart in accordance with an embodiment of the present invention.

FIGS. 2A and 2B are an example of a sequence of screen shots 200 and 202 illustrating an example of creating a functional depth chart in accordance with an embodiment of the present invention.

FIG. 3 is a flowchart illustrating an example of a method of creating an organizational dashboard in accordance with an embodiment of the present invention.

FIG. 4 is an example of a screen shot or the like illustrating an example of portraying an organizational dashboard in accordance with an embodiment of the present invention.

FIG. 5 is a flowchart illustrating an example of a method of performing a functional search in accordance with an embodiment of the present invention.

FIG. 6 is a step diagram of an exemplary system for assessing the functional depth of an organization in accordance with an embodiment of the present invention.

### DETAILED DESCRIPTION OF THE INVENTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system”. Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or step diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or step diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or step diagram step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or step diagram step or steps.

The following detailed description of preferred embodiments refers to the accompanying drawings, which illustrate specific embodiments of the invention. Other embodiments having different structures and operations do not depart from the scope of the present invention.

As described below, an embodiment of the present invention may assess the functional depth of an organization. The functional depth may be generally considered as the levels of expertise of the employees within the organization have on a giving function. Determining the functional depth may involve assessing the various functions of an organization. The requirements of those functions are compared to the existing skill sets of the employees of the organization. A chart may illustrate the function depth of the organization. A user of an embodiment of the present may utilize the function depth to identify staffing gaps and establish plans to fill the staffing gaps. The plans may include the hiring, cross training, promoting, transferring, or the like, of employees.

An embodiment of the present invention may take the form of a software application and process that plots a functional depth chart of an organization. A functional depth chart may illustrate whether an organization has a gap or excess in the amount of employees qualified to fulfill a specific function (hereinafter “function”, “functions”, “function requirement”, or the like). A senior manager or a senior leader may typically manage at least one junior manager or at least one junior leader. An embodiment of the present invention may allow a senior manager, junior manager, functional manager, or other business leader (hereinafter collectivity generally referred to as “leader”, “senior leader”, “junior leader”, or the like) to review, add, modify, or delete at least one function. An embodiment of the present invention may further allow the leader to review, add, modify, or delete, at least one employee record. An embodiment of the present invention may compare the requirements of at least one function (hereinafter function requirement, or the like) with at least one employee record, and plot the results of the comparison, which may illustrate whether or not the at least one employee may be qualified to contribute to fulfilling the function.

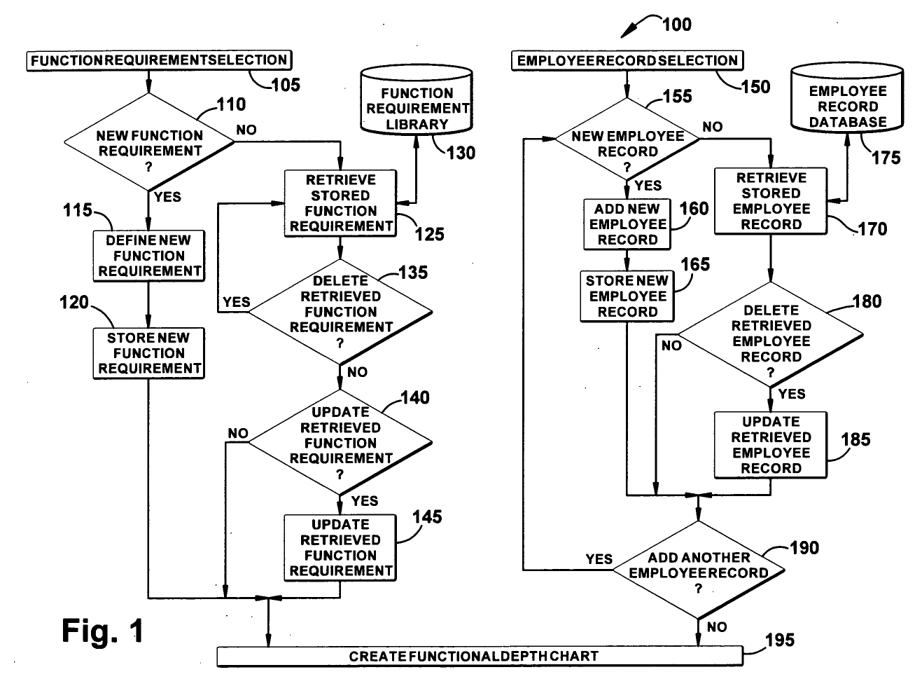

Referring now to the Figures, where the various numbers represent like elements throughout the several views, FIG. 1 is a flowchart illustrating an example of a method 100 of creating a functional depth chart in accordance with an embodiment of the present invention. In step 105, the method 100 selects the function requirement for the organization. Here, a leader, such as for example, but not limited to, a senior manager, may select the function requirement for creating a functional depth chart in step 195. The method 100 may allow for a leader to enter a new function requirement in step 115 or to retrieve a stored function requirement in step 125.

In step 110, the method 100 may determine whether or not a new function requirement may be defined. Here, the method 100 may for example, but not limiting of, require an action by the leader to indicate that a new function requirement will be defined. The action may be for example, but is not limited to, selecting an “enter new function requirement” button, or the like, on a display where the method 100 may be controlled. If a new function requirement is to be defined, then the method 100 proceeds to step 115; otherwise the method 100 precedes step 125.

In step 115, the method 100 may define a new function requirement. Here, the leader may solely define the new function requirement; alternatively the leader may collaborate with others to define the new function requirement. For example, but not limiting of, a senior engineering manager aims to develop a new rotating component, which requires a new function requirement. Here, the senior engineering manager may define the requirements necessary to satisfy the new function, such as for example, but not limiting of, a specific analysis, testing, and validation of the capability of the new rotating component. Thereafter, the method 100 in step 120, may store the new function requirement. The new function requirement may be stored in an existing function requirement library, as discussed in step 130. Moreover, the new function requirement may be stored in any means allowing for the retrieval of the new function requirement. After storing, the method 100 may proceed to step 195.

In step 125, the method 100 may retrieve a previously stored function requirement from the function requirement library. Here, the method 100 may present the leader with the contents of the function requirement library in step 130. The leader may then select a specific function requirement for retrieval and review.

In step 135, the method 100 determines whether the leader would like to delete the retrieved function requirement from the function requirement library. Here the leader, after reviewing a retrieved function requirement, may decide that a new function requirement is required and thus may decide to delete the retrieved function requirement. If the leader decides to delete the retrieved function requirement then the method 100 proceeds to step 140; otherwise the method 100 reverts to step 125.

In step 140, the method 100 determines whether or not to update the retrieved function requirement. Here, the leader may decide to update a function requirement to account for a modified organizational need. If the leader decides to update the retrieved function requirement, then the method 100 proceeds to step 145; otherwise the method 100 proceeds to step 195.

In step 145, the method 100 may provide for updating the retrieved function requirement. The leader upon review of the retrieved function requirement may update the function requirement to comply with an organizational need. Here, changes in the organization may have occurred after the retrieved function requirement was stored. For example, but not limiting of, a function requirement may have included performing an analysis that includes simulating a specific climate such as an arid desert. The organization change may require that a new analysis performed simulating an artic climate. Thus, the functional requirement may need to be updated to account for the new organizational need.

In addition, the leader may change the function requirement based on feedback from other leaders. For example, but not limiting of, a senior leader may change a function requirement after discussing the need for a chance with a junior leader. Moreover, an embodiment of the present invention, may allow for a junior leader to update a retrieved function requirement. After the retrieved function requirement is updated, the method 100 may proceed to step 195.

In step 150, the method 100 may select an employee record for comparison with the selected function requirement (as previously described). Here, a leader, such as a senior manager, may select the employee record for use in creating a functional depth chart in step 195. Generally, each employee record may include the following data: previous job categories, functional experience, performance ratings, career interests, or the like.

An embodiment of the present invention, may for example, but not limiting of, assign at least one employee category to each record of a plurality of employee records. The employee categories may include: an active employee, a potential employee, or a succession employee. An active employee may be considered an employee currently working in an organizational function having the same or similar function requirements as the selected function requirement. A potential employee may be considered an employee who has previously worked in an organizational function having the same or similar function requirements as the selected function requirements. A succession employee may be considered an employee who a leader may suggests has the ability to be educated, trained, or the like, on the selected function requirement.

An embodiment of the present invention may, for example, but not limiting of, assign an employee technical proficiency assessment to each record of a plurality of employee records. The employee ratings may be: a mentor, a verifier, or a performer. An employee that is a mentor may be considered as an expert on a particular function requirement. An employee that is a verifier may be considered as one with sufficient expertise to check another employee's work on a particular functional requirement. An employee that is a performer may be considered as competent in a particular functional requirement yet does not meet the requirements for being a verifier or mentor.

In step 155, the method 100 may determine whether or not to submit a new employee record. Here, the method 100 may for example, but not limiting of, require an action by the leader to indicate that a new employee record may be submitted. The leader action may be, but is not limited to, selecting an “enter new employee record” button, or the like, on a display where the method 100 is controlled. If a new employee record may be submitted, then the method 100 proceeds to step 160; otherwise the method 100 precedes step 170.

In step 160, the method 100 may allow the leader to define a new employee record. The leader may need to define a new employee record where, for example, but not limiting of, a new organization is formed and does not yet have employees to fulfill a function requirement. In step 160, the leader may solely define the new employee record; alternatively the leader may collaborate with others to submit the details of the new employee record. Moreover, the details of a new employee may include for example, but not limiting of, the applicable employee categories, the employee ratings, employee career interests, and suggested career options. Thereafter, the method 100 in step 165, may store the new employee record. The new employee record may be stored in an existing employee record database, as discussed in step 175. Moreover, the new employee record may be stored in any means allowing for retrieval of the new employee record. After storing, the method 100 may proceed to step 190.

In step 170, the method 100 may retrieve a previously stored employee record from the employee record database. Here, the method 100 may present the leader with the contents of the employee record database. The leader may then retrieve a specific employee record for review.

In step 180, the method 100 determines whether or not to update the retrieved employee record. If the leader decides to update the retrieved employee record, then the method 100 proceeds to step 185; otherwise the method 100 proceeds to step 190.

In step 185, the method 100 may provide for updating the retrieved employee record. The leader upon review of the employee record may update the employee record to account for experiences not indicated. For example, but not limiting of, an employee may have completed specific course work or training that is not yet included in the employee record. Also, for example, but not limiting of, either an employee technical proficiency assessment or an employee category, or possibly both, may require updating. In either of the aforementioned examples, the leader may confer with other leaders before updating the employee record.

In addition, the leader may update the employee record based on feedback from other leaders. For example, but not limiting of, a senior leader may update an employee record, after determining that the employee is a potential candidate for a role in the organization. Here, the senior leader may confer with at least one junior leader before updating that employee record. Moreover, an embodiment of the present invention, may allow for a junior leader to update the retrieved employee record. After the retrieved employee record is updated, the method 100 may proceed to step 190.

In step 190, the method 100 may determine whether or not another employee record may be added. Here, the leader may desire to compare a plurality of employee records with the selected function requirement. For example, but not limiting of, a senior leader may be responsible for integrating a plurality of new employees into the organization. Here, the senior leader may need to quickly and accurately to access, which of the plurality of new employee records may fulfill the selected function requirement. If the leader desires to submit an additional employee record, then the method 100 may revert to step 155; otherwise the method 100 may proceed to step 195.

In step 195, the method 100 may create a functional depth chart. As discussed, the functional depth chart may illustrate whether the organization is adequately staffed to fulfill a specific function. For example, but not limiting of, a specific function requirement may require development of an advanced steam turbine component. Here, a leader may need to accurately determine whether the organization has sufficient employee(s) capable of developing the advanced steam turbine component. The functional depth chart may assist the leader in the aforementioned example.

Moreover, in another example, but not limiting or, the leader may need a simple and accurate way to determine the category and rating of the employees within the organization regarding a specific function requirement. Furthering the example, but not limiting of, the leader may need to determine which employees are categorized as active, potential, or successive (as previously described); the leader may also need to determine the employee technical proficiency assessment of each of the categorized employees. As previously described, an employee may be rated as mentor, verifier, or performer; within a specific category. The functional depth chart may assist the leader in the aforementioned example.

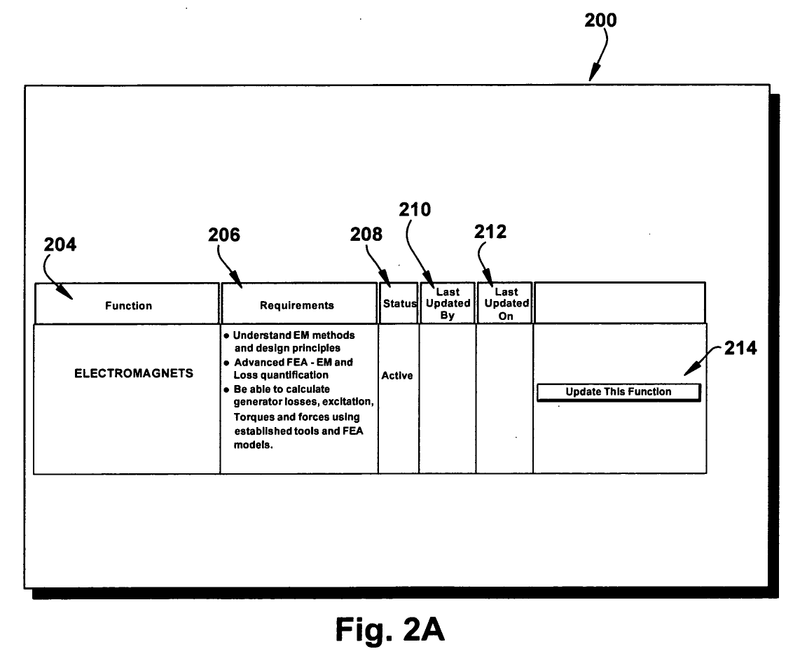

Here, the method 100 in creating the functional “depth” chart, in step 195 compares the selected function requirement, initiated in step 105, with the at least one selected employee record, initiated in step 150. This comparison may yield a function dataset. Next, the method 100 in step 195 may plot the function dataset thereby creating a functional depth chart. The functional depth chart may portray how each employee record fits into the function requirement; as illustrated in FIG. 2B.

Referring now to FIG. 2A and 2B, which are an example of a sequence of screen shots 200 and 202 illustrating an example of creating a functional depth chart in accordance with an embodiment of the present invention. FIG. 2A is specifically a screen shot 200 illustrating a specific function requirement. A caption 204 may indicate which specific function requirement is being reviewed. As discussed, an embodiment of the present invention may allow a leader to define a new function requirement or retrieve a stored function requirement. A requirements field 206 may provide information of the requirements necessary to fulfill the function indicated in the caption 204. The requirements field 206 may allow for leader to: define a new function requirement; or retrieve a stored function requirement, and then review, delete, or update the stored function requirement. The status field 208 may indicate whether the function requirement is active, inactive, or is in use by another leader. The fields 210 and 212 may respectively indicate when the function requirement was last updated and by whom.

An embodiment of the present invention may require that at least one permission be granted before a leader may update a function requirement. For example, but not limiting of; the “update this function” field 214 may be security enabled. This allows a senior leader, or the like, to determine who may either update or delete a function requirement.

Referring now to FIG. 2B, which is an example of a screen shot 202 illustrating an example of a functional depth chart in accordance with an embodiment of the present invention. The method 100 may allow for a leader to select a specific function requirement in the function selection field 220. For example, but not limiting of, the leader may select a function requirement from a drop down list, or the like, associated with the function selection field 220. The function selection field 220 may include a list of function requirements possibly stored in the function requirement library.

Next, the leader may view the functional depth chart by selecting the view chart button 222, whereby the method 100 generates the functional depth chart. In an alternate embodiment of the present invention, the function selection field 220 and the view chart button 222 may be integrated such that the functional depth chart may be automatically generated after the leader selects the function requirement.

The functional depth chart may include a plurality of employee category columns, or the like, including, but not limited to: an active employee 224, a potential employee 226, or a succession employee 228. An active employee may be considered an employee currently working in an organizational function having the same or similar function requirements as the selected function requirement. A potential employee may be considered an employee who has previously worked in an organizational function having the same or similar function requirements as the selected function requirements. A succession employee may be considered an employee who a leader may suggests has the ability to be educated, trained, or the like, on the selected function requirement.

As illustrated in FIG. 2B, the functional depth chart 202 may list each employee in the respective employee category column. An embodiment of the present invention may also include the employee technical proficiency assessment 230 of each employee within the employee category columns. This feature may benefit a leader by visually linking the employee category and the employee technical proficiency assessment for each employee.

The functional depth chart 202 may also include a plurality of depth indicators 232. Each depth indicator 232 may provide the leader with a quick indication of whether sufficient employees may exist within an employee category.

An embodiment of the present invention may allow for a leader to associate the depth indicator 232 with an indicator type 235, such as a color, shape, image, or the like, to signify the current level of technical depth. The indicator type 235 may be classified with a plurality of levels, wherein a each level may indicate for example, but not limiting of, either a sufficient depth, a concerning depth, or an insufficient depth.

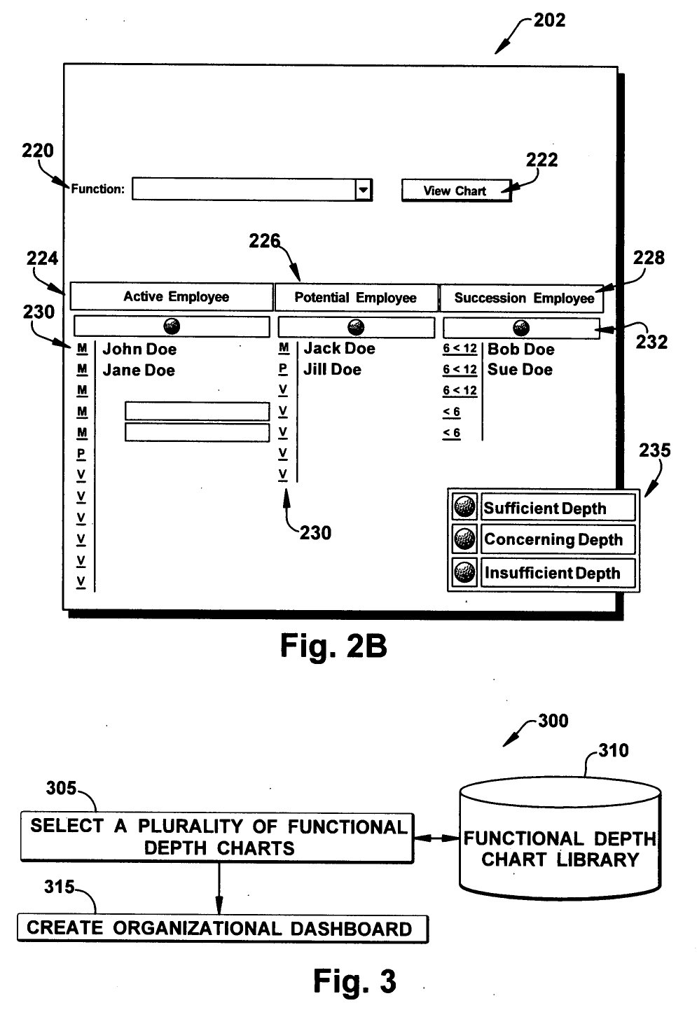

Referring now to FIG. 3, which is a flowchart illustrating an example of a method 300 of creating an organizational dashboard in accordance with an embodiment of the present invention. An organizational dashboard may provide a leader with a broad visual perspective on the organization by combining a plurality of functional depth charts. For example, but not limiting of, the top-level leader in a steam turbine organization may desire to compare a plurality of functional depth charts in order to determine which function has the largest gap in human resources.

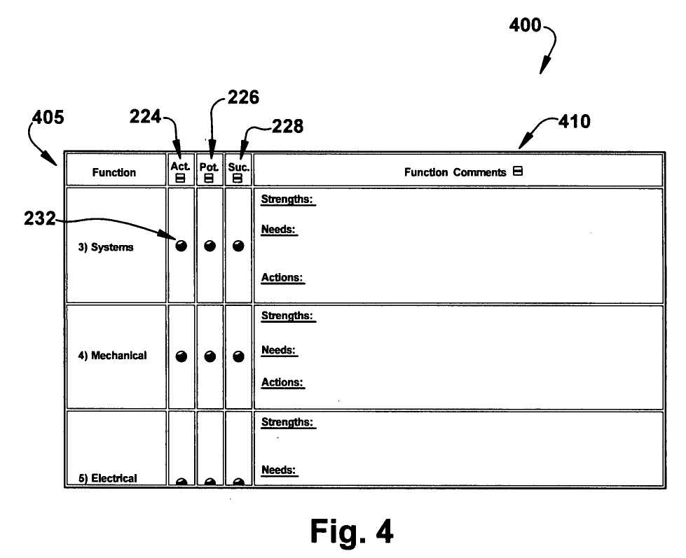

In step 305, the method 300 may allow a leader to select a plurality of functional depth charts. An embodiment of the present invention may allow for the leader to select the plurality functional depth charts from a listing retrieved from a functional depth chart library 310. In step 315, the method 300 may create the organizational dashboard, as further illustrated in FIG. 4.

FIG. 4 is an example of a screen shot or the like illustrating an example of portraying an organizational dashboard 400 in accordance with an embodiment of the present invention. The organizational dashboard 400 may include a selected function field 405 under which the functional depth chart selected by the leader may be portrayed. For example, but not limiting of, a senior engineering leader may desire to compare the staffing among a systems engineering functional depth chart, a mechanical engineering functional depth chart, and an electrical engineering functional depth. Here, the selected function field 405 lists the functional depth charts selected by the senior engineering leader.

The organizational dashboard 400 may integrate a plurality of employee categories that may have been utilized in creating each functional depth chart; such as the active employee 224, the potential employee 226, or the succession employee 228, as previously described. The organizational dashboard 400 may also integrate the plurality of depth indicators 232 that may have been utilized in the creation of each functional depth chart. As discussed, each depth indicator 232 may provide the leader with a quick indication of whether sufficient employees exist within an employee category. The organizational dashboard 400 may also include a comment field 410, which may provide an overall summary of the organization regarding a specific function requirement. For example, but not limiting of, an embodiment of the present invention may include at least one comment field 410 which may provide the strengths, needs, and offer an action plan for the organization, regarding a specific function requirement.

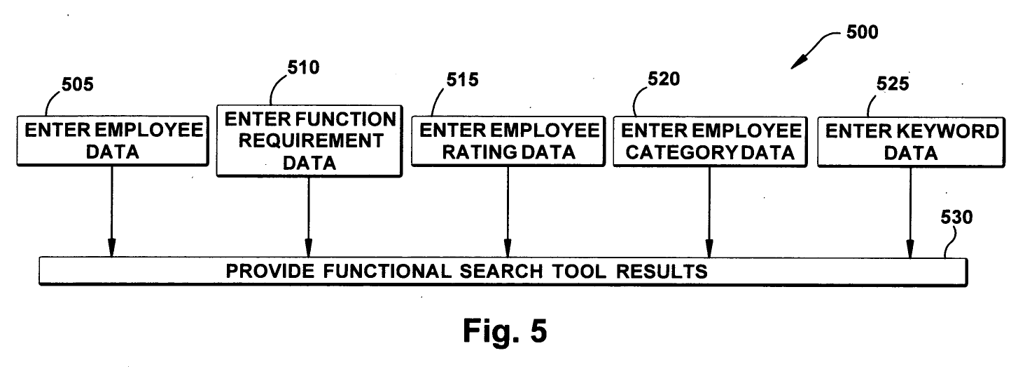

Referring now to FIG. 5, which is a flowchart illustrating an example of a method 500 of performing a functional search in accordance with an embodiment of the present invention. An embodiment of the present invention may allow a leader to enter at least one functional search criteria for performing a search. The functional search criteria may include at least one of: employee data 505; function requirement data 510; employee category data 515; employee technical proficiency assessment data 520; or keyword data 525. An embodiment of the present invention may allow the leader to enter a plurality of functional search criteria. Here, for example, but not limiting of, the leader may enter employee data 505, such as a portion of a name of an employee, along with a function requirement data 510.

An embodiment of the present invention may include for example, but not limiting of, a portion of the name of an employee as the employee data 505. The function requirement data 510 may include for example, but not limiting of, a portion of a function requirement. The employee category data 515 may include for example, but not limiting of, a portion of an employee category. The employee technical proficiency assessment data 520 may include for example, but not limiting of, a portion of an employee rating. The keyword data 525 may include a portion of a specific search term keyword.

After the leader submits at least one of the aforementioned functional search criteria, the method 500, in step 530, may provide the functional search tool results.

As described above, an embodiment of the present invention may assess the functional depth of an organization. The functional depth may be generally considered as the levels of expertise of the employees within the organization have on a giving function. Determining the functional depth may involve assessing the various function of an organization. The requirements of those functions are compared to the skill sets of the employees, if any, of the organization. A chart may illustrate the function depth of the organization. A user of an embodiment of the present may utilize the function depth to identify staffing gaps and establish plans to fill those staffing gaps. The plans may include the hiring, cross training, promoting, transferring, or the like, of employees.

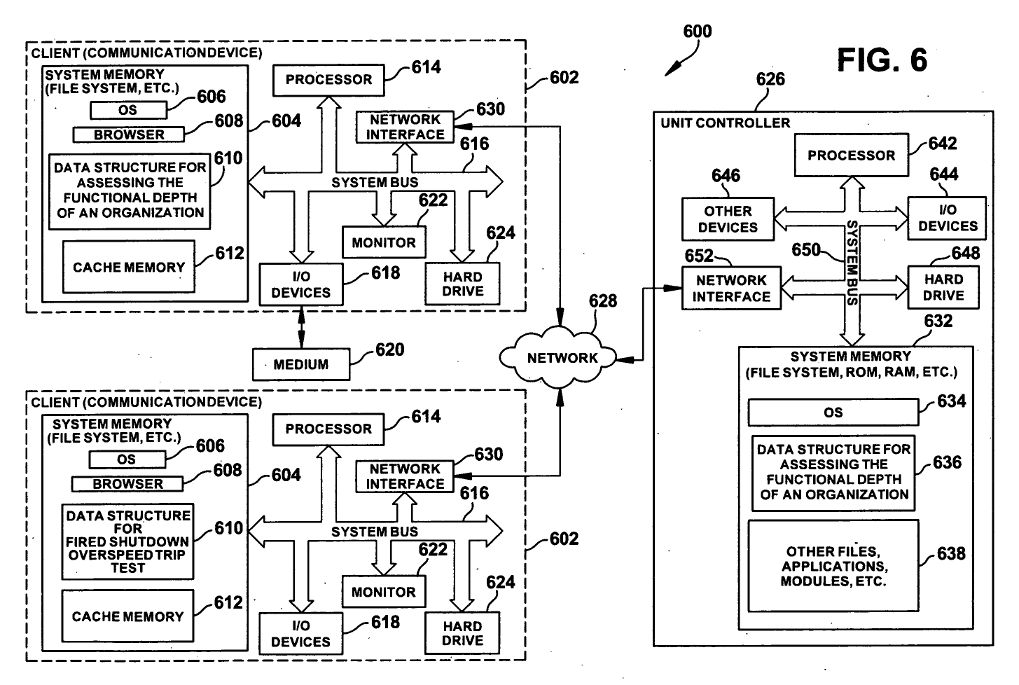

Referring now to FIG. 6, which is a step diagram of an exemplary system 600 for assessing the functional depth of an organization in accordance with an embodiment of the present invention. The elements of the method 100 may be embodied in and performed by the system 600. The system 600 may include one or more user or client communication devices 602 or similar systems or devices (two are illustrated in FIG. 6). Each communication device 602 may be for example, but not limited to, a computer system, a personal digital assistant, a cellular phone, or similar device capable of sending and receiving an electronic message.

The communication device 602 may include a system memory 604 or local file system. The system memory 604 may include for example, but is not limited to, a read only memory (ROM) and a random access memory (RAM). The ROM may include a basic input/output system (BIOS). The BIOS may contain basic routines that help to transfer information between elements or components of the communication device 602. The system memory 604 may contain an operating system 606 to control overall operation of the communication device 602. The system memory 604 may also include a browser 608 or web browser. The system memory 604 may also include data structures 610 or computer-executable code to assess the functional depth of an organization that may be similar or include elements of the method 100 in FIG. 1.

The system memory 604 may further include a template cache memory 612, which may be used in conjunction with the method 100 in FIG. 1 to assess the functional depth of an organization.

The communication device 602 may also include a processor or processing unit 614 to control operations of the other components of the communication device 602. The operating system 606, browser 608, data structures 610 may be operable on the processor 614. The processor 614 may be coupled to the memory system 604 and other components of the communication device 602 by a system bus 616.

The communication device 602 may also include multiple input devices (I/O), output devices or combination input/output devices 618. Each input/output device 618 may be coupled to the system bus 616 by an input/output interface (not shown in FIG. 6). The input and output devices or combination I/O devices 618 permit a user to operate and interface with the communication device 602 and to control operation of the browser 608 and data structures 610 to access, operate and control the software to assess the functional depth of an organization. The I/O devices 618 may include a keyboard and computer pointing device or the like to perform the operations discussed herein.

The I/O devices 618 may also include for example, but are not limited to, disk drives, optical, mechanical, magnetic, or infrared input/output devices, modems or the like. The I/O devices 618 may be used to access a medium 620. The medium 620 may contain, store, communicate, or transport computer-readable or computer-executable instructions or other information for use by or in connection with a system, such as the communication devices 602.

The communication device 602 may also include or be connected to other devices, such as a display or monitor 622. The monitor 622 may be used to permit the user to interface with the communication device 602.

The communication device 602 may also include a hard disk drive 624. The hard drive 624 may be coupled to the system bus 616 by a hard drive interface (not shown in FIG. 6). The hard drive 624 may also form part of the local file system or system memory 604. Programs, software, and data may be transferred and exchanged between the system memory 604 and the hard drive 624 for operation of the communication device 602.

The communication device 602 may communicate with a remote server 626 and may access other servers or other communication devices similar to communication device 602 via a network 628. The system bus 616 may be coupled to the network 628 by a network interface 630. The network interface 630 may be a modem, Ethernet card, router, gateway, or the like for coupling to the network 628. The coupling may be a wired or wireless connection. The network 628 may be the Internet, private network, an intranet, or the like.

The server 626 may also include a system memory 632 that may include a file system, ROM, RAM, and the like. The system memory 632 may include an operating system 634 similar to operating system 606 in communication devices 602. The system memory 632 may also include data structures 636 to assess the functional depth of an organization. The data structures 636 may include operations similar to those described with respect to the method 100 for assessing the functional depth of an organization. The server system memory 632 may also include other files 638, applications, modules, and the like.

The server 626 may also include a processor 642 or a processing unit to control operation of other devices in the server 626. The server 626 may also include I/O device 644. The I/O devices 644 may be similar to I/O devices 618 of communication devices 602. The server 626 may further include other devices 646, such as a monitor or the like to provide an interface along with the I/O devices 644 to the server 626. The server 626 may also include a hard disk drive 648. A system bus 650 may connect the different components of the server 626. A network interface 652 may couple the server 626 to the network 628 via the system bus 650.

The flowcharts and step diagrams in the Figures illustrate the architecture, functionality, and operation of possible implementations of systems, methods, and computer program products according to various embodiments of the present invention. In this regard, each step in the flowchart or step diagrams may represent a module, segment, or portion of code, which comprises one or more executable instructions for implementing the specified logical function(s). It should also be noted that, in some alternative implementations, the functions noted in the step may occur out of the order noted in the figures. For example, two steps shown in succession may, in fact, be executed substantially concurrently, or the steps may sometimes be executed in the reverse order, depending upon the functionality involved. It will also be noted that each step of the step diagrams and/or flowchart illustration, and combinations of steps in the step diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of assessing the functional depth of an organization, the method comprising:
receiving a function requirement;
wherein the step of receiving the function requirement is from at least one of a function requirement library and a new function requirement;
confirming the function requirement, wherein the step of confirming is conducted by at least one member of the organization;
determining whether at least one employee record exists; and if the at least one employee record exists then:
receiving at least one employee record;
wherein the step of receiving the at least one employee record is from at least one of an employee record database and a new employee record;
confirming the at least one employee record, wherein the step of confirming is conducted by at least one member of the organization;
comparing the function requirement and the at least one employee record;
providing a function dataset, wherein the function dataset comprises data from the step of comparing the function requirement and at least one employee record; and
plotting a functional depth chart; wherein the step of plotting the functional depth chart comprises incorporating the function dataset and portraying how each record of the plurality of employee records matches the function requirement.

2. The method of claim 1, wherein the step of receiving the function requirement further comprises at least one senior leader selecting the function requirement, wherein the step of selecting comprises at least one of the following steps:
defining the new function requirement, wherein the new function requirement is stored in a function library;
retrieving an existing function requirement from the function library; wherein after the step of retrieving the existing function requirement a step of performing at least one of the following activities comprises:
reviewing the existing function requirement;
deleting the existing function requirement;
updating the existing function requirement; and
preventing the selected function requirement from being modified.

3. The method of claim 2 further comprising at least one junior leader, wherein the step of retrieving an existing function requirement from the function library, wherein the step of selecting comprises at least one of the following steps:
reviewing the existing function requirement; and
updating the existing function requirement.

4. The method of claim 1, wherein the step of receiving the plurality of employee records further comprises designating at least one employee category to each employee record of the plurality of employee records, and wherein the employee category comprises an active employee, a potential employee, or a succession employee.

5. The method of claim 4, wherein the step of receiving the plurality of employee records further comprises designating an employee technical proficiency assessment to at least one employee record of the plurality of employee records, wherein the employee technical proficiency assessment comprises at least one of a mentor, a verifier, or a performer.

6. The method of claim 1, wherein the step of receiving the plurality of employee records further comprises at least one senior leader selecting the employee record from the plurality of employee records, and wherein the step of selecting comprises at least one of the following steps:
adding a new employee record, wherein the new employee record is stored in an employee database;
retrieving an existing employee record from the employee database;
wherein after the step of retrieving a step of performing at least one of one of the following activities comprises:
reviewing the existing employee record;
deleting the existing employee record;
updating the existing employee record; and
preventing the selected employee record from modification.

7. The method of claim 5, wherein the step of plotting the functional depth chart further comprises:
portraying the employee category required for the function requirement;
portraying the employee technical proficiency assessment required for the function requirement; and
portraying whether the organization comprises a sufficient amount of employee records required for the function requirement.

8. The method of claim 1 further comprising plotting an organizational dashboard, wherein the step of plotting the organizational dashboard comprises:
receiving a plurality of functional datasets; and
portraying the functional depth of a plurality of function requirements.

9. The method of claim 1 further comprising providing a functional search tool, wherein the functional search tool comprises:
receiving a functional search criteria; wherein the functional search criteria comprises at least one of:
an employee data;
the function requirement;
the employee category;
an employee rating; and
a keyword; and
providing the results of the functional search criteria.

10. A method of assessing the functional depth of an organization, the method comprising:
receiving a function requirement;
wherein the step of receiving the function requirement is from at least one of a function requirement library and a new function requirement;
confirming the function requirement, wherein the step of confirming is conducted by at least one member of the organization;
determining whether at least one employee record exists; and if the at least one employee record exists then:
receiving at least one employee record;
wherein the step of receiving the at least one employee record is from at least one of an employee record database and a new employee record;
confirming the at least one employee record, wherein the confirmation is conducted by at least one member of the organization;
comparing the function requirement and the at least one employee record;
providing a function dataset, wherein the function dataset comprises data from the step of comparing the function requirement and at least one employee record; and
plotting a functional depth chart; wherein the step of plotting the functional depth chart comprises incorporating the function dataset and portraying how each record of the plurality of employee records matches the function requirement.
plotting an organizational dashboard, wherein the step of plotting the organizational dashboard comprises:
receiving a plurality of functional datasets; and
portraying the functional depth of a plurality of function requirements;
providing a functional search tool, wherein the functional search tool comprises:
receiving a functional search criteria; wherein the functional search criteria comprises at least one of:
an employee data;
a function requirement;
an employee category;
an employee rating; and
a keyword; and
providing the results of the functional search criteria.

11. A system to assess the functional depth of an organization, the system comprising:
means for receiving a function requirement;
wherein the function requirement is received from at least one of a function requirement library and a new function requirement; and
means for confirming the function requirement, wherein the confirming is conducted by at least one member of the organization;
means for determining whether at least one employee record exist; and if the at least one employee record exists then:
means for receiving at least one employee record;
wherein at least one employee record is received from at least one of an employee record database and a new employee record; and
confirming the at least one employee record, wherein the confirmation is conducted by at least one member of the organization;
means for comparing the function requirement and the at least one employee record;
means for providing a function dataset, wherein the function dataset comprises data from the step of comparing the function requirement and at least one employee record; and
means for plotting a functional depth chart; wherein the functional depth chart comprises the incorporation of the function dataset, and wherein functional depth chart portrays how each record of the plurality of employee records matches the function requirement.

12. The system of claim 11 further comprising means for at least one senior leader to select the function requirement and means for the at least one senior leader to perform at least one of the following activities comprising:
define the new function requirement, wherein the new function requirement is stored in a function library;
retrieve an existing function requirement from the function library;
wherein the at least one senior leader performs at least one of the following activities comprising:
review the existing function requirement;
delete the existing function requirement;
update the existing function requirement; and
prevent the selected function requirement from modification.

13. The system of claim 12 further comprising at least one junior leader, wherein the system provides means for the at least one junior leader to performs at least one of the following activities:
review the existing function requirement; and
update the existing function requirement.

14. The system of claim 11, further comprising means for designating an employee category to at least one employee record to each of the plurality of employee records, wherein the employee category comprises an active employee, a potential employee, or a succession employee.

15. The system of claim 14, further comprising means for designating an employee technical proficiency assessment to each employee record of the plurality of employee records, wherein the employee technical proficiency assessment comprises at least one of a mentor, a verifier, or a performer.

16. The system of claim 11, further comprising means for at least one senior leader to select an employee record from the plurality of employee records and means for the at least one senior leader to perform at least of the following activities:
add a new employee record, wherein the new employee record is stored in an employee database;
retrieve an existing employee record from the employee database;
wherein the at least one senior leader performs at least one of the following activities:
review the existing employee record;
delete the existing employee record;
update the existing employee record; and
prevent the selected employee record from modification.

17. The system of claim 15, further comprising means for plotting the functional depth chart comprises:
means for portraying the employee category required for the function requirement;
means for portraying the employee technical proficiency assessment required for the function requirement; and
means for portraying whether the organization comprises a sufficient amount of employee records required for the function requirement.

18. The system of claim 11 further comprising means for plotting an organizational dashboard, wherein the means for plotting the organizational dashboard comprises:
receiving a plurality of functional datasets; and
portraying the functional depth of a plurality of function requirements.

19. The system of claim 11 further comprising providing means for a functional search tool, wherein the means for providing functional search tool comprises:
receiving a functional search criteria; wherein the functional search criteria comprises at least one of:
an employee data;
a function requirement;
an employee category;
an employee rating; and
a keyword; and
providing the results of the functional search criteria.
